(19) United States
(12) Patent Application Publication
(10) Pub. No.: US 2012/0023433 A1
(43) Pub. Date: Jan. 26, 2012

(54) METHOD AND APPARATUS FOR INPUTTING CHARACTER IN A PORTABLE TERMINAL

(75) Inventors: Yoon-Suk CHOI, Gyeonggi-do (KR); Gi-Tae MUN, Gyeonggi-do (KR); Jong-Hwan LEE, Seoul (KR); Zhong-Hai HAN, Seoul (KR)

(73) Assignee: SAMSUNG ELECTRONICS CO., LTD., Gyeonggi-Do (KR)

(21) Appl. No.: 13/183,699

(22) Filed: Jul. 15, 2011

(30) Foreign Application Priority Data
Jul. 23, 2010 (KR) 10-2010-0071192

(51) Int. Cl. G06F 3/048

(52) U.S. Cl. 715/773

(57) ABSTRACT

A method and apparatus for inputting a character in a portable terminal are provided. The method includes displaying a virtual keypad on a screen, inputting the character by detecting a user touch, predicting at least one next input character associated with the input character, and controlling at least one area between a key area of the predicted character and a key area of an unpredicted character in the virtual keypad so that the respective key area is displayed in different scale for distinction.

This application claims the benefit under 35 U.S.C. § 119(a) of a Korean patent application filed in the Korean Intellectual Property Office on Jul. 23, 2010 and assigned Serial No. 10-2010-0071192, the entire disclosure of which is hereby incorporated by reference.

### BACKGROUND OF THE INVENTION

1. Field of the Invention

The present invention relates to a method and apparatus for inputting a character in a portable terminal. More particularly, the present invention relates to a method and apparatus for inputting a character in a portable terminal that supports a virtual keypad via a touch screen.

2. Description of the Related Art

With the widespread use of portable terminals in recent years, portable terminal providers are competitively developing terminals with more convenient features and additional functions to entice more users. In particular, various functions that require a character input in the portable terminal are under development.

Meanwhile, instead of using a hardware-type keypad device that occupies a fixed space, a touch screen is widely being used to provide a virtual keypad for a slimmer design and compact size.

In the portable terminal that supports a character input mechanism using the aforementioned virtual keypad, respective characters constituting the virtual keypad are located very closely in distance as the touch screen has a limited size. Therefore, there is a high possibility that the user incorrectly inputs a character located near a character to be input.

### SUMMARY OF THE INVENTION

An aspect of the present invention is to solve at least the above-mentioned problems and/or disadvantages and to provide at least the advantages described below.

Accordingly, an aspect of the present invention is to provide a method and apparatus for inputting a character to avoid an incorrect character input in a portable terminal that supports a virtual keypad via a touch screen.

Another aspect of the present invention is to provide a method and apparatus for providing a character input guideline to a user by predicting a character to be input in a portable terminal that supports a virtual keypad via a touch screen.

In accordance with an aspect of the present invention, a method of inputting a character in a portable terminal includes displaying a virtual keypad on a screen, inputting the character by detecting a user touch, predicting at least one next input character associated with the input character, and controlling at least one area between a key area of the predicted character and a key area of an unpredicted character in the virtual keypad so that the key area defining the predicted character and the unpredicted character is displayed distinctively.

In accordance with another aspect of the present invention, an apparatus for inputting a character in a portable terminal includes a touch screen for displaying a virtual keypad on a screen and for detecting a user touch, and a controller for inputting the character according to the detected user touch, for predicting at least one next input character associated with the input character, and for controlling at least one area between a key area of the predicted character and a key area of an unpredicted character in the virtual keypad, so that the key area defining the predicted character and the unpredicted character is displayed distinctively.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating a portable terminal according to an exemplary embodiment of the present invention;

FIG. 2 is a flowchart illustrating a process of inputting a character in a portable terminal according to an exemplary embodiment of the present invention;

FIG. 3 illustrates a screen configuration for predicting a character to be input in a portable terminal according to an exemplary embodiment of the present invention;

FIGS. 4A and 4B illustrate a screen configuration for providing a character input guideline in a portable terminal according to an exemplary embodiment of the present invention;

FIG. 5 illustrates a screen configuration for predicting a character to be input in a portable terminal according to another exemplary embodiment of the present invention; and

FIGS. 6A and 6B illustrate a screen configuration for providing a character input guideline in a portable terminal according to another exemplary embodiment of the present invention.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. For the purposes of clarity and simplicity, descriptions of well-known functions and constructions are omitted to not to obscure the invention.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents. Further, it is to be understood that the singular forms “a,” “an,” and “the” include plural referents unless the context clearly dictates otherwise. Thus, for example, reference to “a component surface” includes reference to one or more of such surfaces.

The present invention described hereinafter relates to a method and apparatus for providing a character input guideline to a user by predicting a character to be input in a portable terminal that supports a virtual keypad by using a touch screen. The portable terminal of the present invention described hereinafter is a terminal that employs a touch screen. Examples of such a portable terminal include a Portable Multimedia Player (PMP), a MPEG-1 Audio Layer 3 (MP3) player, a navigation device, etc.

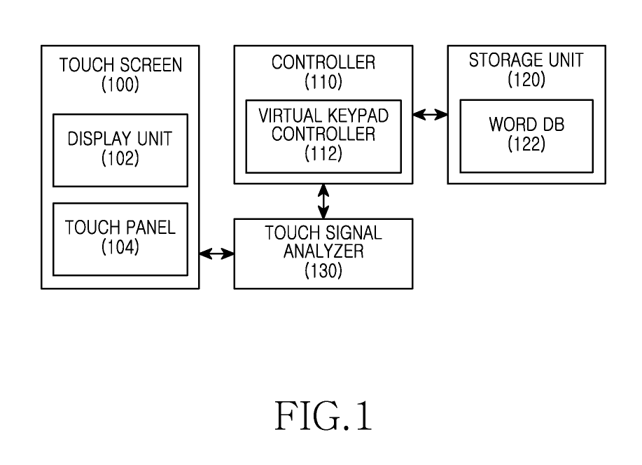

FIG. 1 is a block diagram illustrating a portable terminal according to an exemplary embodiment of the present invention.

Referring to FIG. 1, the portable terminal includes a touch screen 100, a controller 110, a storage unit 120, and a touch signal analyzer 130. The touch screen includes a display unit 102 and a touch panel 104. The controller 110 includes a virtual keypad controller 112. The storage unit 120 includes a word DataBase (DB) 122.

The touch screen 100 includes the display unit 102 and the touch panel 104 disposed above the display unit 102.

The display unit 102 is a Liquid Crystal Display (LCD), and displays status information generated during an operation of the portable terminal, various moving images and still images, etc. In particular, the display unit 102 displays a virtual keypad on the screen to input a character, and reduce a key area of an unpredicted character on the virtual keypad under the control of the controller 110. Herein, the keypad may have a Qwerty keyboard format or a 3×4 keypad format. The format of the virtual keypad may change variously.

In addition, the touch panel 104 recognizes an electrical analog signal depending on a contact made on the screen and delivers the recognition result to the touch signal analyzer 130.

The touch signal analyzer 130 analyzes the electrical analog signal provided from the touch panel 104 included in the touch screen 100, and outputs a location coordinate depending on a location at which the contact is made on the screen to the controller 110.

The controller 110 controls and processes overall operations of the portable terminal. In particular, by including the virtual keypad controller 112, the controller 110 performs a function for controlling a size of key areas included in the virtual keypad displayed on the display unit 102 when a character is input.

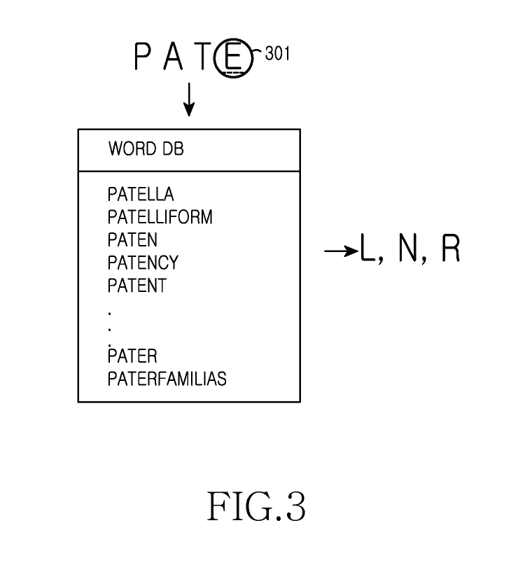

The virtual keypad controller 112 evaluates a character corresponding to a key area touched by a user by using the location coordinate input from the touch signal analyzer 130, and determines the evaluated character as a current input character. The virtual keypad controller 112 searches the word DB 122 stored in the storage unit 120 according to at least one the current input character and a character string which has been input up to now, and predicts a next input character. For example, as illustrated in FIG. 3, if a character which is input by a current touch is “e” and a current input character string is “pate”, the virtual keypad controller 112 searches the word DB 122 to find words (i.e., patella, patelliform, paten, patency, . . . , pater, etc.) corresponding to the “pate”, and can predict any one of “l”, “n”, and “r” as the next input character.

If a specific number (or more) of characters are predicted as a next input character, the virtual keypad controller 112 may determine only the specific number (or less) of characters as predicted next input characters by considering a usage frequency of word. That is, the virtual keypad controller 112 searches the word DB 122 to find words corresponding to the character string which has been input up to now. If a result of predicting the next input character from the found words shows that the number of predicted characters is greater than or equal to the specific number, the virtual keypad controller 112 may select only the specific number of words frequently used among the found words and then may predict the next input character from the selected words. Of course, for this, the storage unit 120 or the word DB 122 has to store information indicating how frequently the user uses each word, and the virtual keypad controller 112 has to update a usage frequency of a corresponding word whenever one complete word is input.

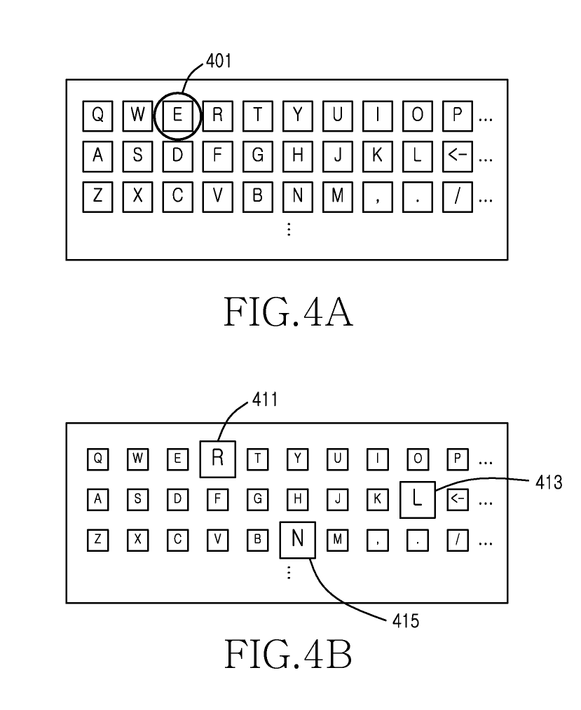

If the next input character is predicted, the virtual keypad controller 112 controls a function for reducing a size of a key area corresponding to the remaining characters other than the predicted next input character in the virtual keypad. For example, if “l”, “n”, and “r” are predicted as the next input character in a state where the current input character is a character “e” 401 as illustrated in FIG. 4A, the virtual keypad controller 112 can reduce the key area of the remaining characters other than the character “l” 413, the character “n” 415, and the character “r” 411 in the virtual keypad as illustrated in FIG. 4B. Herein, the virtual keypad controller 112 reduces the key area of the unpredicted characters in order to facilitate an input of the next character by intuitively recognizing the predicted next input character. Also, the virtual keypad controller 112 reduces the key area of the unpredicted characters in order to decrease generation of an incorrect input by preventing a touch on key area of unpredicted character.

Further, the virtual keypad controller 112 may turn off a touch detection function with respect to the key area of the unpredicted characters in order to avoid the incorrect input of the user, or may ignore the detected touch operation even if a touch is detected for the key area of the unpredicted characters. Furthermore, the virtual keypad controller 112 may decrease a probability of incorrect inputs of unpredicted characters by separately displaying the predicted characters on an area other than the virtual keypad area.

In addition, since the user may want to input a word not existing in the word DB 122, the virtual keypad controller 112 is allowed to turn on/off a function for controlling the virtual keypad according to user's manipulation. For example, when assuming a situation where the user inputs a schedule, the function for controlling the virtual keypad can be turned off throughout time when the schedule is input. Alternatively, the function for controlling the keypad can be turned off only during time when a specific word or character is input while the schedule is input. For example, if the user intends to input a word “patent”, the virtual keypad control function may be turned on until “pate” out of “patent” is input, but after the inputting of “pate”, the keypad control function may be turned off by using a predetermined function key, icon, or menu and then “nt” may be input.

The storage unit 120 stores data and a variety of programs for overall operations of the portable terminal, and stores the word DB 122 according to the present invention. The word DB 122 includes words of a language for characters constituting the keypad. For example, the word DB 122 may include a DB including English words and a DB including Korean words.

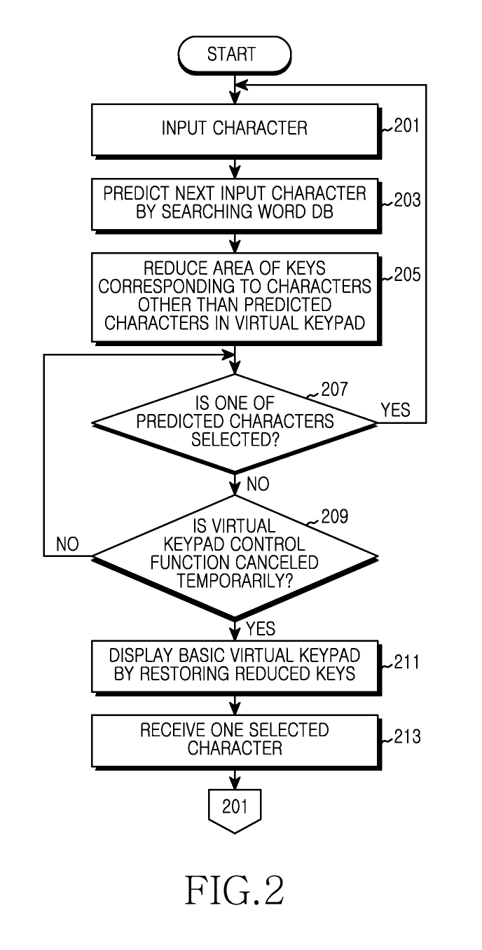

FIG. 2 is a flowchart illustrating a process of inputting a character in a portable terminal according to an exemplary embodiment of the present invention.

Referring to FIG. 2, the portable terminal receives a character corresponding to a key area touched by a user in a state where a virtual keypad is displayed on a touch screen in step 201.

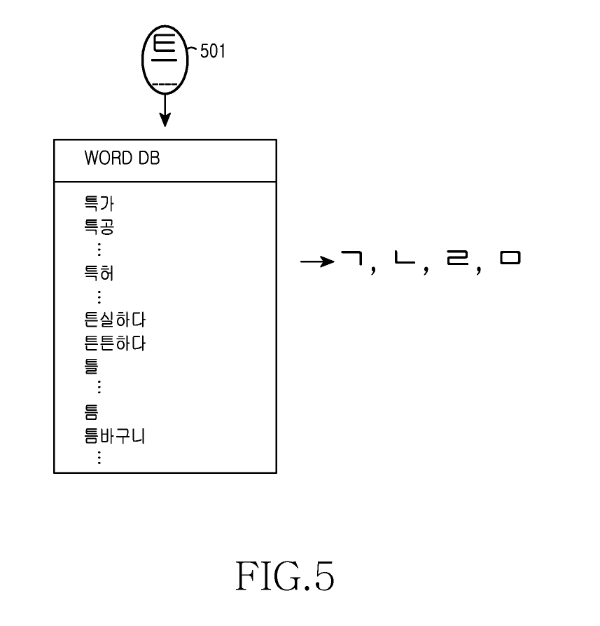

In step 203, the portable terminal searches the word DB 122 to find words corresponding to a current input character or character string, and predicts a next input character on the basis of the found words. For example, as illustrated in FIG. 3, if a character which is input by a current touch is “e” and a current input character string is “pate”, the portable terminal searches the word DB 122 to find words (i.e., patella, patelliform, paten, patency, . . . , pater, etc.) corresponding to the “pate”, and can predict from the found words that any one of “l”, “n”, and “r” can be input next to the word “e”. In addition, as illustrated in FIG. 5, if the current input character is “ [symbol] ” and the current input character string is “ [symbol] ”, the portable terminal searches the word DB 122 to find words corresponding to “ [symbol] ” (i.e., [symbol] , [symbol] , . . . , [symbol] , . . . , [symbol] , [symbol] , [symbol] , . . . , [symbol] , [symbol] , etc.), and can predict that any one of “ [symbol] ”, “ [symbol] ”, “ [symbol] ”, and “ [symbol] ” can be input next to “ [symbol] ” from the found words. Herein, if the portable terminal predicts a specific number (or more) of characters to be input as a next input character, the portable terminal may predict only the specific number (or less) of characters as the next input character by considering a word usage frequency.

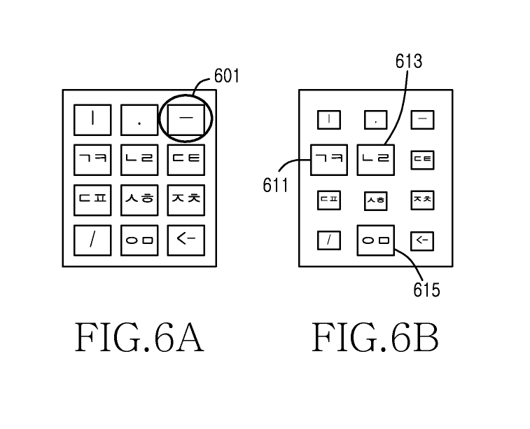

In step 205, the portable terminal reduces an area of keys corresponding to characters other than the predicted characters in a virtual keypad displayed on the touch screen. For example, if “l”, “n”, and “r” are predicted as the next input character in a state where the current input character is the character “e” 401 as illustrated in FIG. 4A, the portable terminal can reduce the key area of the remaining characters other than the character “l” 413, the character “n” 415, and the character “r” 411 in the virtual keypad as illustrated in FIG. 4B. In addition, as illustrated in FIG. 6A, if “ [symbol] ”, “ [symbol] ”, “ [symbol] ”, and “ [symbol] ” are predicted as the next input character in a state that the current input character is a character “ [symbol] ” 601, the portable terminal can reduce a key area of the remaining characters other than characters “ [symbol] ” 611, “ [symbol] ” 613, “ [symbol] ” 613, and “ [symbol] ” 615 predicted as the next input character in the virtual keypad as illustrated in FIG. 6B.

In step 207, the portable terminal examines whether one of the predicted characters is selected by a user's touch. When one of the predicted characters is selected, returning to step 201, the portable terminal receives the selected character, and then the subsequent steps are repeated. Of course, after the predicted character is input, the portable terminal restores the reduced key areas to the original size.

For example, as illustrated in FIG. 3, if “l”, “n”, and “r” are predicted as a next input character in a state where “pate” is input and “n” is input among the predicted characters, then words (e.g., paten, patency, patent, etc.) corresponding to “paten” which has been currently input are searched from the world DB 122 and then “c”, “t”, and a blank character can be predicted as the next input character. Herein, if the character string which has currently been input is a word having one meaning, the portable terminal can predict that the blank character is input as the next input character.

Otherwise, if one of the predicted characters is not selected, proceeding to step 209, the portable terminal examines whether an event for temporarily canceling or stopping a virtual keypad control function is generated by the user. The event may occur by an input of a function key predetermined by the user, an icon touch, or menu setting. If the event for temporarily canceling or stopping the virtual keypad control function does not occur, the procedure returns to step 207. Otherwise, if the event occurs, proceeding to step 211, the portable terminal restores the key areas reduced in step 205 and displays a basic virtual keypad. The reason above is to prepare for a case where the user wants to input a word not existing in the word DB 122.

Thereafter, the portable terminal receives one character selected on the virtual keypad by the user's touch in step 213, and then returning to step 201, the subsequent steps are repeated.

According to exemplary embodiments of the present invention, a portable terminal that supports a virtual keypad provides a character input guideline to a user by predicting a character to be input. Therefore, a possibility of incorrectly inputting a character can be decreased, and a character can be easily input even if a user does not recognize a character configuration of the keypad.

The above-described methods according to the present invention can be implemented in hardware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method of inputting a plurality of characters in a portable terminal, the method comprising:
displaying a virtual keypad on a screen;
inputting at least one character by detecting a user touch;
predicting at least one next input character associated with the input character; and
selectively adjusting a key area of the at least one predicted next input character in the virtual keypad.

2. The method of claim 1, wherein adjusting the key area of the next input character in the virtual keypad comprises reducing a key area of at least one unpredicted character by a predetermined amount.

3. The method of claim 1, wherein the next input character is predicted based a user's history in usage frequency of words.

4. The method of claim 1, wherein adjusting the key area of the next input character in the virtual keypad comprises enlarging the key area of the next input character by a predetermined amount.

5. The method of claim 1, wherein adjusting the key area of the next input character in the virtual keypad comprises enlarging the key area of the next input character substantially larger than the key area of at least one unpredicted character.

6. The method of claim 1, wherein adjusting the key area of the next input character in the virtual keypad comprises turning off a touch detection function for the key area of the unpredicted character.

7. The method of claim 1, wherein adjusting the key area of the next input character in the virtual keypad comprises ignoring a detected touch operation upon detecting a touch in the key area of the unpredicted character.

8. The method of claim 1, wherein the next input character is predicted based on words corresponding to the input character among pre-stored words.

9. The method of claim 7, wherein the predicting of the next input character is based on a usage frequency of each of words corresponding to the input character.

10. The method of claim 1, further comprising displaying the next input character on an area other than the virtual keypad area.

11. The method of claim 1, further comprising storing and updating information indicating how frequently a particular word is used.

12. An apparatus for inputting a plurality of characters in a portable terminal, comprising:
a touch screen for displaying a virtual keypad on a screen; and
a controller for inputting at least one input character, for predicting at least one next input character associated with the input character, and for selectively adjusting a key area of the predicted character and a key area of an unpredicted character in the virtual keypad.

13. The apparatus of claim 12, wherein the controller reduces the key area of the unpredicted character by a predetermined amount.

14. The apparatus of claim 12, wherein the controller turns off a touch detection function for the key area of the unpredicted character.

15. The apparatus of claim 12, wherein the controller ignores a detected touch operation for the key area of the unpredicted character.

16. The apparatus of claim 12, further comprising a storage unit for storing a plurality of words, wherein the controller predicts the next input character based on a usage frequency of each of words corresponding to the input character.

17. The apparatus of claim 12, wherein adjusting the key area of the next input character in the virtual keypad comprises enlarging the key area of the next input character by a predetermined amount.

18. The apparatus of claim 12, wherein adjusting the key area of the next input character in the virtual keypad comprises enlarging the key area of the next input character substantially larger than the key area of at least one unpredicted character.

19. The apparatus of claim 12, further the controller further displays the next input character on an area other than the virtual keypad area.

20. The apparatus of claim 12, further the controller further stores and updates information indicating how frequently a particular word is used.
